(19) United States
(12) Patent Application Publication
(10) Pub. No.: US 2006/0188087 A1
(43) Pub. Date: Aug. 24, 2006

(54) System and method for caller-controlled music on-hold

(75) Inventors: Philip T. Kortum, Austin, TX (US); Benjamin Andrew Knott, Round Rock, TX (US); Robert R. Bushey, Cedar Park, TX (US)

Correspondence Address: TOLER SCHAFFER, LLP, 5000 PLAZA ON THE LAKES, SUITE 265, AUSTIN, TX, 78746, US

(73) Assignee: SBC Knowledge Ventures, LP

(21) Appl. No.: 11/062,100

(22) Filed: Feb. 18, 2005

(51) Int. Cl. H04M 3/00

(52) U.S. Cl. 379/266.01

(57) ABSTRACT

The present disclosure provides a system and method configured to provide a caller with selectable music options when the caller is on hold. The method establishes a connection between a caller and a receiving system, wherein the receiving system is configured to retrieve one of the plurality of music selections. The caller can select music from a plurality of selections. The system and method can provide a menu driven interaction and utilize voice commands and touchtone input to provide selected music to the caller.

### FIELD OF THE DISCLOSURE

The present disclosure relates generally to telephone communications and more particularly to on-hold activities for a caller during a telephone call.

### BACKGROUND

Millions of telephone calls are made to call centers and to individuals conducting businesses during every business hour. Generally, a call center is an organization of people, telecommunications equipment, and management software for efficiently handling telephone based customer contact. Often when a call is made to an individual or a call center, the individual, agent or service desired by the caller is temporary unavailable. When this occurs, a caller is typically put “on-hold.” When a customer is on-hold there is a variety of audio that can be provided to a customer. For example, many telephone answering systems play advertisements while other systems play music from a local radio station or Musak™. Other telephone systems repeatedly provide a message such as “Please hold” . . . “Please hold” on and on for the entire time that a caller is on hold. Audio is typically provided to pacify a caller and let a caller know that they are still “connected” with the receiving system.

Recent studies have shown that customer satisfaction is increased and the perceived on-hold time duration is reduced if a caller enjoys the music they are listening to while on hold. As call centers cut costs and reduce employee counts, a customer can be on hold for several minutes before an agent or a system becomes available. When callers are required to listen to a repetitive “Please Hold” or “Please Wait” cue for several minutes, they can become annoyed. Another way that callers can be annoyed while they are on hold is when the system plays background music that is offensive to the caller. Waiting on-hold for long periods of time can frustrate customers and can produce reduced customer satisfaction. If a caller does not like the audio provided, the caller may hang up and abandon the call. Most call centers handle huge volumes of calls and, even if a small percentage of calls are abandoned, the cost associated with abandoned calls is significant. Accordingly, there is a need for a call handling system with an improved on-hold interface.

### BRIEF DESCRIPTION OF THE DRAWINGS

FIG. 1 illustrates a simplified configuration of a telecommunications system; and

FIG. 2 is a flow diagram that illustrates a method of providing user selectable music while on-hold during a call.

### DETAILED DESCRIPTION OF THE DRAWINGS

The present disclosure provides a system and method configured to provide a caller with selectable music options when the caller is on-hold. The method establishes a connection between a caller and a receiving system, wherein the receiving system is configured to retrieve one of the plurality of music selections. The caller can select music from a plurality of selections. The system and method can provide a menu driven interaction and utilize voice commands and touchtone input to provide selected music to a caller when the selection is available. In a particular embodiment, a caller on-hold system is disclosed. The caller on-hold system includes an on-hold caller interface to provide user selectable audio during a call, the on-hold caller interface includes a processor configured to prompt a caller for a specific music selection based upon available music selections and to process a request from the caller for the specific music selection.

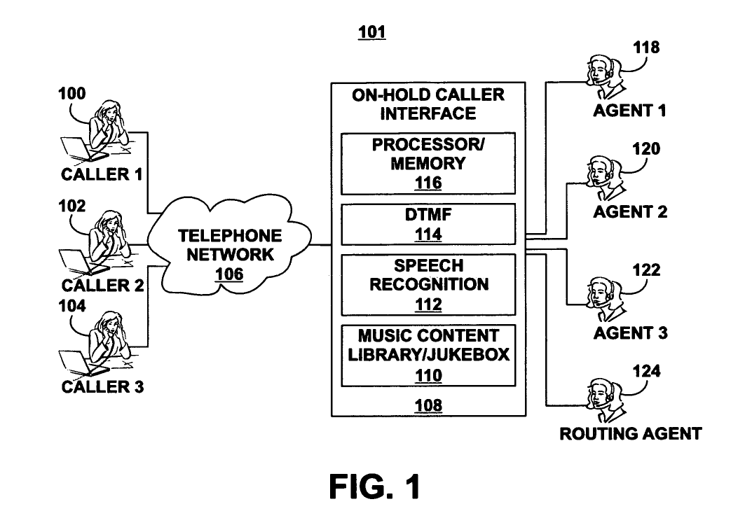

Referring to FIG. 1, an illustrated communication system 101 that includes an on-hold caller interface 108 is shown. The communication system 101 includes a plurality of representative callers 100, 102, and 104 coupled to a telephone network 106, which can utilize telephony, IP protocols, or the like to couple the callers 100-104 to the on-hold caller interface 108. On-hold caller interface 108 can include a processor with a memory 116, a dual-tone multi-frequency detector (DTMF) 114, speech recognition module 112, and a music supply, music content library/jukebox 110. The on-hold caller interface 108 can be coupled to a first agent 118, a second agent 120, a third agent 122, and a routing agent 124.

When the first caller 100 places a call to a call center over the telephone network 106, the caller 100-104 may be placed on hold due to the unavailability of agents 118-124. When it is determined that the caller 100-104 is put on hold, the on-hold caller interface 108 can prompt the caller 100-104 regarding what the caller 100-104 would like to listen to while on hold. The operations of the on-hold telephone interface can be performed utilizing instructions retrieved from memory and executed by the processor 116.

In one example, a requested agent is unavailable and the on-hold caller interface 108 provides a voice prompt to the caller of, “What kind of music would you like to listen to?” The caller may reply, “I would like to listen to rock music.” The speech recognition system 112 would convert the speech input into text and instruct the on-hold caller interface 108 to reply, “What specific artist or song would you like to hear?” The caller may reply with a specific song or artist request. Speech recognition module 112 can communicate with the music content library 110 to locate and retrieve the caller's request. The music content library 110 can then provide the music selection via the on-hold caller interface 108 over the telephone network 106 to the caller 100-104. During the on-hold period, a caller may interrupt the process and request different or additional songs and other information. Alternately, caller input could be in the form of a touchtone input of touch-tone response that can be recognized by the DTMF detector 114.

The music provided to the caller while on-hold can be terminated when an agent 118-124 becomes available or upon a caller request. Thus, when an agent 118-124 becomes available, the on-hold caller interface 108 can create or receive a control signal and connect the caller 100-104 to one of the agents 118-124. Alternately, the speech recognition system 112 can monitor the caller's line for caller commands and act on the caller's command. When a caller's utterance is not understood the speech recognition system 112 can provide additional queries to address a caller's request. For example, a caller may indicate that they want to replay the current song, play a different song, a different artist or a next song on a playlist.

Music content library 110 may be implemented utilizing a data (music) storage system that is proximate to the telephone system. The data storage system may provide music in a digital or an analog format. For example, the music may be provided in MP3, WMA, WAVE, AVI, or any other suitable format. Music may also be supplied to a caller via an analog format such as an FM radio format. In one configuration a recording organization can advertise newly released songs to the caller when the new songs are available from a music supplier. The data storage system may be remotely located from the caller interface system 108 wherein the data/music may be transported from the remote location in real-time by radio waves, over telephone lines, or over the Internet. The music content library 110 may store music utilizing compact discs or a tape media. In one embodiment a CD music content library/jukebox that can accept digital commands such as those implemented by radio stations may be utilized. A remotely located music system may be operated by a service provided for the call center. For example, music content library 110 may be a jukebox or a digital based satellite radio system such as XM or SIRIUS radio.

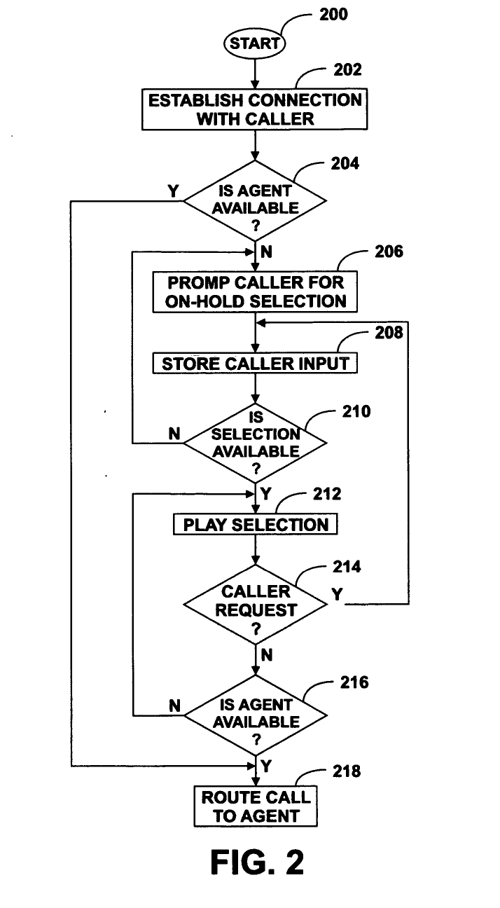

Referring to FIG. 2, an illustrative embodiment of a method of processing a user request for on-hold music is illustrated. The method starts at 200 and proceeds to step 202 where a connection is established between a caller and a call receiving system. The method determines whether the agent or system requested by the caller is available to the caller at step 204. If the agent is available, the call is routed to the agent as shown in step 218. If the agent or system is not available, the call progresses to step 206 where the caller is prompted for a personalized on-hold selection.

The caller can be prompted in many different ways in order to efficiently match a caller's desires with available music selections. The system could prompt the caller announcing the available genres, available artists, and available songs. Additionally, the caller could merely request a specific song and the method could determine if the specific music selection is available. When a first selection is unavailable a second dialog could attempt to locate a secondary selection. The caller may also request to advance the song to a specific portion of the song, request that the music selection be replayed or request that the music be paused. Further, the caller could request to hear many samples of different songs, or request to hear newly released songs or top ranked hits. The selected music can be downloaded over the Internet or any media that can provide adequate bandwidth. The caller input is stored at step 208, and the method determines if the caller's request can be addresses. In one example a caller's selection of music is determined to be available, at step 210.

If the selection or request is unavailable the method proceeds back to step 206 to prompt the caller for another selection. When a caller provides a request, the method proceeds to step 208 to store the new input. When a selection is available, the caller's selection is played at step 212. The method continually monitors the call for caller input, at step 214. When a pause in caller input occurs, the method checks to see if the assigned agent of system is available to the caller at step 216.

If the agent or system is still unavailable at step 216, the method proceeds back to step 212, where the method continues to play the caller's selection. When the agent or system becomes available, the call is routed to the agent or system at step 218 and the music is stopped.

The above-disclosed subject matter is to be considered illustrative, and not restrictive, and the appended claims are intended to cover all such modifications, enhancements, and other embodiments that fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method comprising:
establishing a connection with a caller at a receiving system, the receiving system configured to retrieve one of a plurality of music selections;
processing a caller request for a specific music selection from the plurality of music selections; and
playing the specified music selection to the caller over the connection.

2. The method of claim 1, further comprising providing the caller with available artists associated with the plurality of music selections.

3. The method of claim 2, further comprising providing the caller with a selectable list of songs available from the artist.

4. The method of claim 1, wherein the method further comprises determining if the specific music selection is available.

5. The method of claim 4, further comprising prompting the caller for a second selection when the specific music selection is not available.

6. The method of claim 1, wherein the specific music selection is stored utilizing a digital format.

7. The method of claim 6, wherein the digital format is one of an MP3, CD, XM and wave format.

8. The method of claim 1, further comprising processing a verbal request from a caller for the specific music selection.

9. The method of claim 1, further comprising terminating play of the specific music selection in response to one of a caller command and a control signal indicating that an agent has become available.

10. The method of claim 1, further comprising retrieving a second music selection based on a caller command.

11. The method of claim 1, further comprising advancing the requested music selection based on a caller command.

12. The method of claim 1, further comprising replaying the requested music selection based on a caller command.

13. The method of claim 1, further comprising playing selectable top ranked hits based on a caller command.

14. The method of claim 1, wherein the caller selects an artist and music that is associated with the artist is played to the caller.

15. The method of claim 1, further comprising providing an audio clip indicating the plurality of music selections available to the caller.

16. The method of claim 1, further comprising advertising newly released songs from a music source when the new songs are available from a music supplier.

17. The method of claim 1, further comprising downloading music over the Internet.

18. A caller on-hold system comprising:
an on-hold caller interface to provide user selectable audio during a call, the on-hold caller interface comprising;
a processor configured to prompt a caller for a specific music selection based upon available music selections and to process a request from the caller for the specific music selection.

19. The system of claim 18, further comprising a music storage system coupled to the processor to provide music to the on-hold caller interface.

20. The system of claim 18, further comprising a speech recognition module configured to receive speech from the caller, the processor to provide music based on the received speech.

21. The system of claim 18, further comprising a dual tone multi-frequency (DTMF) detector, the processor to provide music to the caller in response to DTMF input.

22. The system of claim 18, further comprising a telephone network configured to establish a connection between the caller and a receiving system.
